(19) United States
(12) Patent Application Publication
(10) Pub. No.: US 2023/0264981 A1
(43) Pub. Date: Aug. 24, 2023

(54) MANAGEMENT METHOD OF ULTRAPURE WATER PRODUCTION SYSTEM

(71) Applicant: SAMSUNG ELECTRONICS CO., LTD., Suwon-si (KR)

(72) Inventors: Younhaeng LEE, Incheon (KR); Cheolmin Shin, Iksan-si (KR); Changyeol Ham, Yongin-si (KR); Jieun Jang, Pyeongtaek-si (KR)

(73) Assignee: SAMSUNG ELECTRONICS CO., LTD., Suwon-si (KR)

(21) Appl. No.: 18/083,124

(22) Filed: Dec. 16, 2022

(30) Foreign Application Priority Data
Feb. 22, 2022 (KR) 10-2022-0022974

(51) Int. Cl. C02F 1/28; C02F 1/42; C02F 1/461; C02F 1/72; C02F 1/32; C02F 1/58

(52) U.S. Cl. CPC C02F 1/285; C02F 1/42; C02F 1/46104; C02F 1/72; C02F 1/32; C02F 1/58; C02F 2101/108

(57) ABSTRACT

A management method of a system for producing an ultrapure water, the system including a boron removal tower including an accommodation space through which water to be processed passes and a boron adsorption resin filling the accommodation space of the boron removal tower, and the boron removal tower including a plurality of sample ports through which a plurality of sample waters to be processed passing through portions having different heights of the boron adsorption resin, are respectively discharged, and determining a replacement cycle of the boron adsorption resin by increasing a passing flow rate of the boron removal tower.

### CROSS-REFERENCE TO RELATED APPLICATION(S)

This application claims priority to Korean Patent Application No. 10-2022-0022974, filed on Feb. 22, 2022 in the Korean Intellectual Property Office, the disclosure of which is incorporated by reference herein in its entirety.

### BACKGROUND

The present disclosure relates to a management method of a system for producing an ultrapure water.

As an important solvent widely used in a semiconductor manufacturing process, ultrapure water has been used for various purposes in various processes. Impurities contained in ultrapure water may act as a risk factor causing defects of products in a semiconductor manufacturing process, for example, an exposure process. Impurities contained in ultrapure water are a major issue with regard to the quality of the ultrapure water and are periodically subject to careful monitoring. With the recent trend for a semiconductor device having a higher degree of integration and a smaller size, removal of impurities contained in ultrapure water has been considered to be an important issue in process management.

### SUMMARY

One or more example embodiments provide an efficient management method of a system for producing an ultrapure water for producing high-quality ultrapure water.

Additional aspects will be set forth in part in the description which follows and, in part, will be apparent from the description, or may be learned by practice of the presented embodiments.

According to an aspect of an example embodiment, a management method of a system for producing an ultrapure water, the system including a boron removal tower including an accommodation space through which water to be processed passes and a boron adsorption resin filling the accommodation space of the boron removal tower, the boron adsorption resin including a plurality of sample resin layers provided in a direction in which the water to be processed in the accommodation space flows, and the boron removal tower including a plurality of sample ports through which sample processing water obtained from the plurality of sample resin layers is discharged, may include supplying the water to be processed to the boron removal tower, passing the water to be processed through the boron adsorption resin, measuring an amount of residual boron from sample processing water obtained from each of the plurality of sample ports, determining a leakage sample resin layer, among the plurality of sample resin layers, reaching a break-through point based on the amount of the residual boron, deriving a depth of a leakage region of the boron adsorption resin based on a location of the leakage sample resin layer reaching the break-through point, and determining a lifespan of the boron adsorption resin based on the derived depth of the leakage region and an operating period corresponding to a period of operating the system until the determination of the leakage sample resin layer reaching the break-through point.

According to an aspect of an example embodiment, a management method of a system for producing an ultrapure water including an electrodeionization device and a boron removal device, wherein water to be processed, discharged from the electrodeionization device, is directly introduced into the boron removal device, the boron removal device includes a plurality of boron removal towers each including an accommodation space through which the water to be processed passes and a boron adsorption resin filling the accommodation space of each of the plurality of boron removal towers, and the boron adsorption resin including a plurality of sample resin layers provided in a direction in which the water to be processed in the accommodation space flows, and each of the plurality of boron removal towers includes a plurality of sample ports through which sample processing water obtained from the plurality of sample resin layers is discharged, may include determining a replacement cycle of the boron adsorption resin by increasing a passing flow rate of the water to be processed in at least one of the plurality of boron removal towers. The determining of the replacement cycle may include measuring an amount of residual boron from sample processing water obtained from each of the plurality of sample ports, determining a leakage sample resin layer, among the plurality of sample resin layers, reaching a break-through point based on the amount of the residual boron, deriving a depth of a leakage region of the boron adsorption resin based on a location of the leakage sample resin layer reaching the break-through point, and determining the lifespan of the boron adsorption resin based on the derived depth of the leakage region and an operating period corresponding to a period of operating the system until the determination of the leakage sample resin layer reaching the break-through point.

According to an aspect of an example embodiment, a management method of a system for producing an ultrapure water, the system comprising a boron removal tower comprising an accommodation space through which water to be processed passes and a boron adsorption resin filling the accommodation space of the boron removal tower, and the boron removal tower comprising a plurality of sample ports through which a plurality of sample waters to be processed passing through portions having different heights of the boron adsorption resin, are respectively discharged, may include determining a replacement cycle of the boron adsorption resin by increasing a passing flow rate of the boron removal tower. The determining the replacement cycle may include measuring an amount of residual boron in arbitrary sample processing water, among the plurality of sample waters to be processed, deriving a height of a leakage sample port in which a break-through point is observed and through which the arbitrary sample processing water is discharged, based on the amount of the residual boron, and determining the lifespan of the boron adsorption resin based on the derived height and an operating period corresponding to a period of operating the system until reaching the break-through point.

### BRIEF DESCRIPTION OF THE DRAWINGS

The above and other aspects, features, and advantages of certain example embodiments of the present disclosure will be more apparent from the following description taken in conjunction with the accompanying drawings, in which:

FIG. 1 is a diagram illustrating a system for producing an ultrapure water according to example embodiments;

FIG. 2 is a diagram illustrating a portion of a system for producing an ultrapure water according to example embodiments;

FIG. 3 is a diagram illustrating a portion of a system for producing an ultrapure water according to example embodiments;

FIG. 4 is a diagram illustrating an example of a boron removal tower of a boron removal device according to example embodiments; and

FIG. 5 is a flowchart illustrating a management method of a system for producing an ultrapure water according to example embodiments.

### DETAILED DESCRIPTION

Hereinafter, example embodiments will be described with reference to the accompanying drawings.

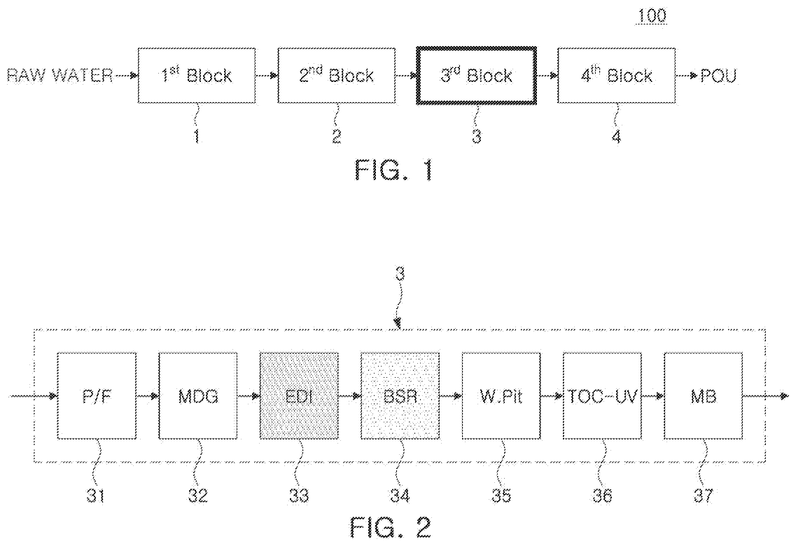

FIG. 1 is a diagram illustrating a system for producing an ultrapure water according to example embodiments.

Referring to FIG. 1, a system 100 for producing an ultrapure water may include a first block 1, a second block 2, a third block 3, and a fourth block 4. The system 100 for producing an ultrapure water may supply ultrapure water, produced by removing impurities contained in raw water, to a point of use (POU), a place at which the ultrapure water is used. The raw water may be tap water, well water, underground water, industrial water, water used in a semiconductor fabrication factory and then recovered and treated (recovered water), or the like.

The first block 1 may be a preprocessing unit, and may remove suspended solids in raw water to generate preprocessing water and supply the preprocessing water to the second block 2. The first block 1 may be configured by appropriately selecting, for example, a sand filtration device or a microfiltration device for removing suspended solids in raw water, and may be configured to further include a heat exchanger for controlling a temperature of the raw water, as necessary. For example, the first block 1 may include at least one of an activated carbon device for removing chlorine (Cl) and suspended solids with an activated carbon filter, or the like, an ultrafiltration device, and a reverse osmosis device. The first block 1 may be omitted depending on quality of the raw water.

The second block 2 may be a first pure water production unit or a primary pure water system, and may include at least one of a reverse osmosis device for removing salts or ionic organic materials and colloidal organic materials in preprocessing water, a degassing device (a decarbonation column, a vacuum degassing device, a membrane degassing device, or the like), and an ultraviolet oxidation device. The second block 2 may remove bacteria and organic materials in the preprocessing water to produce primary pure water, and may supply the primary pure water to the third block 3. According to example embodiments, the reverse osmosis devices may be connected in two stages in series to constitute a two-stage reverse osmosis device. The degassing device may be provided to remove dissolved carbon dioxide in processing water obtained by a reverse osmosis device. The ultraviolet oxidation device may include an ultraviolet lamp for irradiating ultraviolet light to water to be processed, and may be provided to decompose and sterilize viable cells, bacteria, and the like, in the water to be processed.

The third block 3 is a secondary pure water production unit or subsystem, and may include at least one of an ion exchange device (a cation exchange device, an anion exchange device, a mixed-bed ion exchange device, or the like), an ultraviolet oxidation device, and a degassing device. The third block 3 may remove ionic components, non-ionic components, and dissolved gas in the primary pure water to produce secondary pure water, and may supply the secondary pure water to the fourth block 4. The third block 3 may include a boron removal device for removing boron. This will be further described with reference to FIG. 2.

The fourth block 4 is a polishing unit, and may include a polisher device. As necessary, the fourth block, 4 may further include at least one of a heat exchanger, an ultraviolet oxidation device, an ion exchange device, a degassing device, and an ultrafiltration device. The polisher device may include an ion exchange resin and may remove ionic materials in the water to be processed. In the fourth block 4, an extremely small amount of an organic material may be oxidized and decomposed with ultraviolet light using an ultraviolet oxidation device to be removed, and may then pass through an ultrafiltration device to produce final semiconductor grade ultrapure water.

The first, second, and third blocks 1, 2, and 3 may include a make-up process of producing pure water, and the fourth block 4 may include a polishing process of producing ultrapure water.

FIG. 2 is a diagram illustrating a portion of a system for producing an ultrapure water according to example embodiments.

Referring to FIG. 2, the third block 3 of the system 100 for producing an ultrapure water may include, for example, a prefilter (P/F) 31, a membrane degassing device (MDG) 32, an electrodeionization device (EDI 33 (e.g., a continuous electrodeionization device (CEDI), a boron removal device (BSR) 34, a water storage pit (W.Pit) 35, an ultraviolet oxidation device (TOC-UV) 36, and an ion exchange device (MB) 37.

The prefilter 31 may include a microfilter, and may remove suspended solids in the water to be processed. The prefilter 31 may be provided with a plurality of prefilters 31. The prefilter 31 may filter, for example, particles having a size of about 1 μm or more from the water to be processed.

The membrane degassing device 32 may remove carbon dioxide and/or oxygen in the water to be processed. The membrane degassing device 32 may separate gas, dissolved in a liquid, using a hollow fiber membrane. In the membrane degassing device 32, a hydrophobic membrane such as porous polypropylene (PP) or polymethylpentene (PMP) may be used as a material of the hollow fiber membrane. Therefore, the membrane degassing device 32 is characterized in not allowing liquid to pass therethrough while allowing only gas to pass therethrough. The membrane degassing device 32 may include a membrane degassing module filled with porous hollow fibers therein, and hollow fiber layers may divisionally form a flow path, through which the water to be processed flows, and a flow path through which the dissolved gas separated from the water to be processed flows.

The electrodeionization device 33 may include an ion exchange membrane, an ion exchange resin, and may have a structure in which cation exchange membranes and anion exchange membranes are alternately disposed with respective ion exchange resins filled therebetween. When direct current (DC) power is supplied to electrodes on opposite ends, cations of the water to be processed may pass through the cation exchange membrane and move toward a cathode, and anions may pass through the anion exchange membrane and move toward an anode. The electrodeionization device 33 may be divided into three compartments such as a dilution container, a concentration container, and an electrode container, and the ion exchange resin filling the dilution container may decrease electrical resistance, serving to allow current to flow well and to increase ion mobility. The electrodeionization device 33 may be a continuous electrodeionization device (CEDI). The electrodeionization device 33 may remove about 98% or more of boron in the water to be processed.

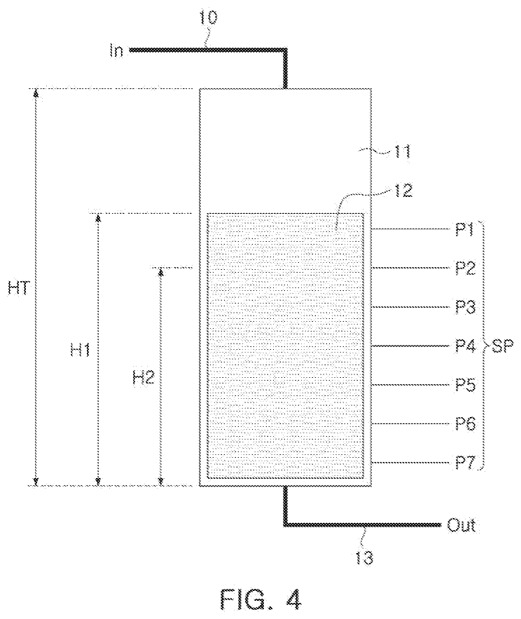

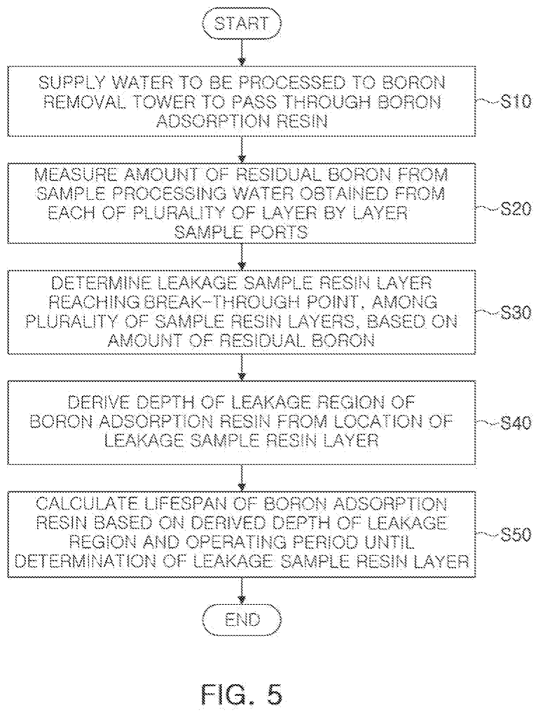

The boron removal device 34 may be connected to a rear end of the electrodeionization device 33. When the electrodeionization device 33 includes two-stage electrodeionization devices 33, a boosting pump may be disposed between the two-stage electrodeionization devices 33. On the other hand, when the boron removal device 34 is connected to a rear end of a single-stage electrodeionization device 33, boron removal efficiency may be improved and a boosting bump is not required, so that power consumption and facility area usage may be significantly reduced. A concentration of boron in the water to be processed may be decreased to 1 ppt or less using the boron removal device 34. The boron removal device 34 may include a boron adsorption resin and a boron removal tower accommodating the boron adsorption resin therein (see FIG. 4). The ultrapure water production system may be efficiently managed through a method of predicting a lifespan of the boron removal device 34 (see FIG. 5).

The water storage pit 35 may serve as a buffer between various devices to stably maintain a flow rate and water quality of pure (deionized) water or ultrapure water to be produced. The water storage pit 35 may be connected to a rear end of the boron removal device 34. In some example embodiments, the water storage pit 35 may be disposed in other locations in the block or may be omitted.

The ultraviolet oxidation device 36 may be connected to a rear end of the boron removal device 34. The ultraviolet oxidation device 36 may include, for example, an ultraviolet lamp for irradiating ultraviolet light having a wavelength of about 185 nm, and may oxidize and decompose total organic carbon (TOC) in the water to be processed through a process in which the ultraviolet lamp irradiates ultraviolet light to the water to be processed. Water may be decomposed by the ultraviolet light to generate OH radicals, and the OH radicals may oxidize and decompose organic materials contained in the water to be processed. The boron adsorption resin of the boron removal device 34 may elute the organic materials into the water to be processed. The organic material, contained in the water to be processed, may be an organic component generated mainly by decomposing the boron adsorption resin, a small amount of an organic component derived from raw water, and an organic component dissociated by a pipe or the like. The ultraviolet oxidation device 36 may decrease a concentration of TOC in the water to be processed from about 30 ppb to about 3 ppb.

The ion exchange device 37 may be connected to a rear end of the ultraviolet oxidation device 36. The ion exchange device 37 may remove cations and anions contained in the water to be processed. The ion exchange device 37 may remove TOC decomposition byproducts or organic ions generated in the process in which the ultraviolet oxidation device 36 removes the organic materials eluted from the boron removal device 34.

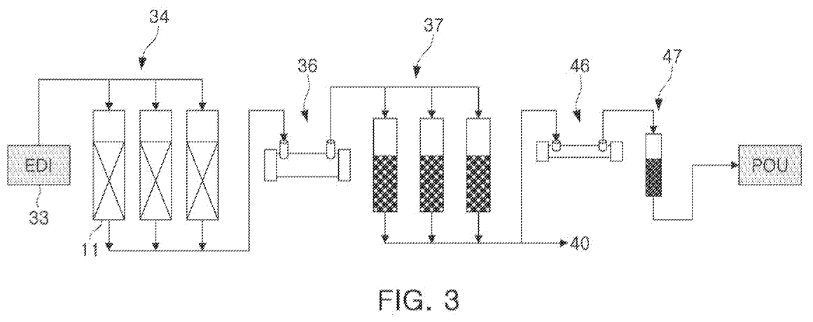

FIG. 3 is a diagram illustrating a portion of a system for producing an ultrapure water according to example embodiments.

Referring to FIG. 3, in a system for producing an ultrapure water 100, an example of devices through which the water to be processed discharged from the electrodeionization device 33 is supplied to a POU is illustrated. The system 100 for producing an ultrapure water may include a boron removal device 34, a first ultraviolet oxidation device 36, a first ion exchange device 37, a second ultraviolet oxidation device 46, and a second ion exchange device 47.

The boron removal device 34 is a device through which the processing water of the electrodeionization device 33 passes. The boron removal device 34 may include a plurality of boron removal towers 11 connected to each other in parallel. The plurality of boron removal towers 11 may have an accommodation space through which the water to be processed passes, and the boron adsorption resin 12 may fill the accommodation space. A water flow rate in the plurality of boron removal towers 11 may be a space velocity of, in detail, 1 to 100 (l/h) in terms of long-term boron removal. The space velocity be, in detail, about 60 (l/h) to optimize removal efficiency achieved by adsorbing boron in the plurality of boron removal towers 11.

The first ultraviolet oxidation device 36 may be connected to a rear end of the boron removal device 34. The water to be processed, discharged from the plurality of boron removal towers 11, may be introduced into the first ultraviolet oxidation device 36. The water to be processed, passing through the boron removal device 34, may be supplied to a POU via the second ultraviolet oxidation device 46.

The first ion exchange device 37 may include an ion exchange tower and an ion exchange resin filling at least a portion of the ion exchange tower. The first ion exchange device 37 may be in a state in which a plurality of first ion exchange devices are connected to each other in parallel. The ion exchange resin may include a strongly acidic cation exchange resin and/or a strongly basic anion exchange resin. The water to be processed, passing through the boron removal device 34, may be supplied to the POU via the second ion exchange device 47.

FIG. 4 is a diagram illustrating an example of a boron removal tower of a boron removal device according to example embodiments. FIG. 5 is a flowchart illustrating a management method of a system for producing an ultrapure water according to example embodiments. The management method may include determining a replacement cycle of a boron adsorption resin through a lifespan evaluation method of predicting a lifespan of the boron adsorption resin.

Referring to FIG. 4, the boron removal device 34 may include a boron removal tower 11, a boron adsorption resin 12 filling at least a portion of the accommodation space of the boron removal tower 11, an inlet portion 13 introducing the water to be processed from the boron removal tower 11 into the boron removal tower 11, and an outlet portion 13 discharging the processing water through the boron adsorption resin 12 from the boron removal tower 11 to the outside. The water to be processed, introduced into the boron removal tower 11 from the inlet portion 10, may pass through the boron adsorption resin 12, boron present in the water to be processed may be adsorbed to the boron adsorption resin 12, and boron-removed processing water may be discharged through the outlet portion 13. The boron removal tower 11 may have a cylindrical resin tower structure, and may be filled with the boron adsorption resin 12. A resin, obtained by adding a functional group having an alcohol group as a boron adsorption group to a polystyrene resin, or a phenol resin may be used as the boron adsorption resin 12. The boron adsorption resin 12 may be, in detail, an ion exchange resin including a methylglucamine group having high boron adsorption capacity. The management method may be a method of managing the residual boron concentration of the processing water, discharged to the outlet portion 13, to be 1 ppt or less.

Referring to FIGS. 4 and 5, in operation S10, the water to be processed may be supplied to the boron removal tower 11 to pass through the boron adsorption resin 12.

The boron adsorption resin 12 may fill the boron removal tower 11 to a first height H1. The boron removal tower 11 may have a height HT, greater than the first height H1. The water to be processed may be supplied into the accommodation pace of the boron removal tower 11 from the inlet portion 10. The boron adsorption resin 12 may include a plurality of sample resin layers disposed in a direction in which the water to be processed flows in the accommodation space of the boron removal tower 11, and the boron removal tower 11 may include a plurality of sample ports SP (P1 through P7), which may be arranged layer by layer, through which sample processing water obtained from the plurality of sample resin layers is discharged. The plurality of layer by layer sample ports SP may be disposed at different heights. The plurality of layer by layer sample ports SP may provide an outlet portion through which a portion of the processing water, passing through the boron adsorption resin 12, is discharged. In each of the plurality of layer by layer sample ports SP, a residual boron concentration of processing water passing through a sample resin layer may be measured. A plurality of layer by layer sample ports SP may be provided for each of the plurality of boron removal towers 11. For example, the plurality of layer by layer sample ports SP may be disposed to be spaced apart from a bottom of the boron removal tower 11 by a predetermined interval. The number of layer by layer sample ports SP, provided in a single boron removal tower 11, may vary according to example embodiments.

The water to be processed may be supplied to each of the plurality of boron removal towers 11. Passing flow rates and/or space velocities of the water to be processed, supplied to the plurality of boron removal towers 11, may be the same or different from each other. As an example, the lifespan evaluation method of predicting a lifespan of the boron adsorption resin 12 may include increasing the passing flow rate and/or space velocity of the water to be processed in a portion of the plurality of boron removal towers 11 and then calculating a lifespan of the boron adsorption resin 12 based on determination of a leakage sample resin layer. Increasing the passing flow rate and/or space velocity of the water to be processed may be harsh test conditions. For example, the water to be processed may pass through the first boron removal tower at a first space velocity, and may pass through the second boron removal tower at a second space velocity, greater than the first space velocity. As an example, the first space velocity may be about 60 (l/hr), and the second space velocity may be about 90 (l/hr), about 1.5 times greater than the first space velocity. For the lifespan evaluation method, the increased passing flow rate of the water to be processed, passing through the boron removal tower 11, may be about 2.5 m³/h to about 3.0 m³/h. Since the passing flow rates or the space velocities of the plurality of boron removal towers 11 are set under different conditions, an additional drain pipe 40 may be provided.

In operation S20, the amount of residual boron may be measured from sample processing water obtained from each of the plurality of layer by layer sample ports SP.

The water to be processed, passing through the boron removal tower 11, may sequentially pass through a plurality of sample resin layers. In the process, boron contained in the water to be processed may be adsorbed to a plurality of sample resin layers of the boron adsorption resin 12. The sample processing water, passing through each of the sample resin layers, may be obtained from the outlet portion of the plurality of layer by layer sample ports SP provided in the boron removal tower 11, and the amount of residual boron in each sample processing water may be measured.

In operation S30, among the plurality of sample layers, a leakage sample resin layer reaching a break-through point may be determined based on the amount of the residual boron.

When a lifespan of the boron adsorption capacity of the sample resin layer in an arbitrary sample port SP expires, a sample resin layer may reach a break-through point at which the amount of residual boron contained in the sample processing water passing through the sample resin layer starts to be increase. A leakage sample resin layer may be a sample resin layer, reaching the break-through point, among the plurality of sample resin layers in the plurality of sample ports SP. When there is a portion in which the boron adsorption resin 12 has reached the break-through point at a specific height, the boron adsorption resin 12 on a higher level may be in a state in which boron adsorption capacity thereof is lost. Alternatively, the boron adsorption resin 12 on a lower level may be in a state in which boron adsorption capacity remains.

In operation S40, a depth of the leakage region of the boron adsorption resin 12 may be derived from a location of the leakage sample resin layer reaching the break-through point.

The depth of the leakage region may be defined as a value obtained by subtracting a height H2 corresponding to a sample port in which a leakage sample resin layer is disposed, for example, P2 from a total height H1 of the boron adsorption resin 12. The height H2 may correspond to a remaining height of the boron adsorption resin 12 in which the boron adsorption capacity remains. The height H2 may correspond to a height of the leakage sample port for discharging sample water to be processed in which the break-through point was observed.

In operation S50, the lifespan of the boron adsorption resin 12 may be calculated based on the derived depth of the leakage region and an operating period until the determination of the leak sample resin layer. The lifespan of the boron adsorption resin 12 may be calculated as in Equation (1).

Lifespan (days)=(total height of boron adsorption resin (H1)/depth of leakage region (H1−H2))×operating period (days)×SV conversion (1)

The SV conversion (e.g., space velocity conversion) may be calculated as a space velocity of the water to be processed, under severe test conditions compared to the space velocity of the normal target water. For example, the SV conversion may be defined as a rate of increasing a passing flow rate of the water to be processed under the harsh test conditions. As an example, the SV conversion may be calculated as a ratio of the first space velocity to the second space velocity. The SV conversion may range from about 1.2 to about 2.0.

The operating period may correspond to a period of operating the ultrapure water production system until the determination of the leakage sample resin layer reaching the break-through point. The operating period may correspond to an operating period of the ultrapure water production system until a specific portion of the boron adsorbent resin 12 in an arbitrary sample processing water reaches the break-through point.

Since the boron adsorption resin 12 leaks boron ions when reaching the break-through point, it may be significantly important to evaluate an appropriate lifespan of the boron adsorption resin 12 such that high-quality ultrapure water is supplied to a point of use. This is because an appropriate replacement cycle of the boron adsorption resin 12 may be determined only by evaluating the appropriate lifespan of the boron adsorption resin 12. According to example embodiments, the lifespan of the boron adsorption resin 12 may be predicted by a lifespan evaluation method in some boron removal towers 11 while operating the boron removal device 34, such that a user may recognize a replacement cycle of the boron adsorption resin 12 of the boron removal device 34 in advance to replace the boron adsorption resin 12.

As an example, water to be processed passed at a space velocity of 90 (l/hr), a harsh condition, for 391 days after preparing a boron adsorption resin 12 having a height H1 of about 900 mm in the boron removal tower 112 and forming sample ports SP. As a result, a sample port SP disposed at a height H2 of about 710 mm corresponded to a lowermost sample port SP in which a small amount of boron leaks. According to example embodiments, as a result of estimating the lifespan of the boron adsorption resin 12, when the water to be processed passed through the boron removal tower 11 at a space velocity of 60 (l/hr), it was found that the boron adsorption resin 12 may be replaced after about 2778 days (about 7.5 years or more).

As described above, according to one or more example embodiments, an efficient management method of a system for producing an ultrapure water for producing high-quality ultrapure water may be provided.

As described above, one or more example embodiments provide an ultrapure water system in which a boron specific ion exchange resin is disposed on a rear end of a continuous electrodeionization device. Boron rejection efficiency may be improved, and power consumption and facility area usage may be reduced because a boosting bump is not required. One or more example embodiments also provide a method of predicting a lifespan of a boron specific ion exchange resin to predict a periodic replacement time of the boron specific ion exchange resin, as a boron specific ion exchange resin may require periodic replacement.

While example embodiments have been shown and described above, it will be apparent to those skilled in the art that modifications and variations could be made without departing from the scope of the present inventive concept as defined by the appended claims.

What is claimed is:

1. A management method of a system for producing an ultrapure water, the system comprising a boron removal tower having comprising an accommodation space through which water to be processed passes and a boron adsorption resin filling the accommodation space of the boron removal tower, the boron adsorption resin comprising a plurality of sample resin layers disposed in a direction in which the water to be processed in the accommodation space flows, and the boron removal tower comprising a plurality of sample ports through which sample processing water obtained from the plurality of sample resin layers is discharged, the management method comprising:
supplying the water to be processed to the boron removal tower to pass through the boron adsorption resin;
measuring an amount of residual boron from sample processing water obtained from each of the plurality of sample ports;
determining a leakage sample resin layer, among the plurality of sample resin layers, reaching a break-through point based on the amount of the residual boron;
deriving a depth of a leakage region of the boron adsorption resin based on a location of the leakage sample resin layer reaching the break-through point; and
determining a lifespan of the boron adsorption resin based on the derived depth of the leakage region and an operating period corresponding to a period of operating the system until the determination of the leakage sample resin layer reaching the break-through point.

2. The management method of claim 1, wherein the plurality of sample resin layers are provided at predetermined intervals from a bottom of the boron removal tower.

3. The management method of claim 1, wherein the boron removal tower comprises a plurality of boron removal towers connected in parallel.

4. The management method of claim 3, wherein the plurality of boron removal towers comprises a first boron removal tower and a second boron removal tower, and
wherein, in an operation of supplying the water to be processed to the boron removal tower, the water to be processed passes through the first boron removal tower at a first space velocity and passes through the second boron removal tower at a second space velocity that is greater than the first space velocity.

5. The management method of claim 4, wherein the determining the lifespan of the boron adsorption resin comprises calculating the lifespan of the boron adsorption resin according to:
lifespan (days)=(a total height of the boron adsorption resin/a depth of the leakage region)×the operating period (days)×SV conversion, and
wherein the SV conversion is a ratio of the first space velocity to the second space velocity.

6. The management method of claim 4, wherein the first space velocity is about 60 (l/h), and
wherein the second space velocity is about 90 (l/h).

7. The management method of claim 1, wherein the boron adsorption resin comprises an ion exchange resin including a methylglucamine group.

8. The management method of claim 1, wherein the system further comprises a first block, a second block, and a third block,
wherein the third block comprises an electrodeionization device and a boron removal device,
wherein the boron removal device comprises the boron removal tower and the boron adsorption resin, and
wherein the boron removal device is connected to a rear end of the electrodeionization device.

9. The management method of claim 8, wherein the third block further comprises:
a membrane degassing device connected to a front end of the electrodeionization device,
an ultraviolet oxidation device connected to a rear end of the boron removal device, and
an ion exchange device connected to a rear end of the ultraviolet oxidation device.

10. The management method of claim 8, wherein the first block comprises at least one of a heat exchanger, an activated carbon device, an ultrafiltration device, and a reverse osmosis device.

11. The management method of claim 8, wherein the second block comprises at least one of a reverse osmosis device, a degassing device, and an ultraviolet oxidation device.

12. A management method of a system for producing an ultrapure water comprising an electrodeionization device and a boron removal device, wherein water to be processed, discharged from the electrodeionization device, is directly introduced into the boron removal device, the boron removal device comprises a plurality of boron removal towers each comprising an accommodation space through which the water to be processed passes and a boron adsorption resin filling the accommodation space of each of the plurality of boron removal towers, and the boron adsorption resin comprising a plurality of sample resin layers disposed in a direction in which the water to be processed in the accommodation space flows, and each of the plurality of boron removal towers comprises a plurality of sample ports through which sample processing water obtained from the plurality of sample resin layers is discharged, the management method comprising:
determining a replacement cycle of the boron adsorption resin by increasing a passing flow rate of the water to be processed in at least one of the plurality of boron removal towers,
wherein the determining the replacement cycle comprises:
measuring an amount of residual boron from sample processing water obtained from each of the plurality of sample ports;
determining a leakage sample resin layer, among the plurality of sample resin layers, reaching a break-through point based on the amount of the residual boron;
deriving a depth of a leakage region of the boron adsorption resin based on a location of the leakage sample resin layer reaching the break-through point; and
determining the lifespan of the boron adsorption resin based on the derived depth of the leakage region and an operating period corresponding to a period of operating the system until the determination of the leakage sample resin layer reaching the break-through point.

13. The management method of claim 12, wherein the determining the lifespan of the boron adsorption resin comprises calculating the lifespan of the boron adsorption resin according to:
lifespan (days)=(a total height of the boron adsorption resin/a depth of the leakage region)×the operating period (days)×SV conversion, and
wherein the SV conversion comprises a rate of increasing the passing flow rate of the water to be processed.

14. The management method of claim 13, wherein the SV conversion ranges from about 1.2 to about 2.0.

15. The management method of claim 12, wherein the boron removal device further comprises an inlet portion connected to an upper side of each of the plurality of boron removal towers, and an outlet portion connected to a lower side of each of the plurality of boron removal towers.

16. The management method of claim 15, wherein a concentration of residual boron of processing water, discharged to the outlet portion, is managed to be 1 ppt or less.

17. The management method of claim 12, wherein the system further comprises an ultraviolet oxidation layer connected to a rear end of the boron removal device to remove organic materials eluted from the boron removal device.

18. The management method of claim 17, wherein the system further comprises an ion exchange device configured to remove total organic carbon (TOC) decomposition byproducts or organic ions generated in a process in which the ultraviolet oxidation layer removes the organic materials eluted from the boron removal device.

19. A management method of a system for producing an ultrapure water, the system comprising a boron removal tower comprising an accommodation space through which water to be processed passes and a boron adsorption resin filling the accommodation space of the boron removal tower, and the boron removal tower comprising a plurality of sample ports through which a plurality of sample waters to be processed passing through portions having different heights of the boron adsorption resin, are respectively discharged, the management method comprising:
determining a replacement cycle of the boron adsorption resin by increasing a passing flow rate of the boron removal tower,
wherein the determining the replacement cycle comprises:
measuring an amount of residual boron in arbitrary sample processing water, among the plurality of sample waters to be processed;
deriving a height of a leakage sample port in which a break-through point is observed and through which the arbitrary sample processing water is discharged, based on the amount of the residual boron; and
determining the lifespan of the boron adsorption resin based on the derived height and an operating period corresponding to a period of operating the system until reaching the break-through point.

20. The management method of claim 19, wherein the boron adsorption resin comprises boron adsorption capacity on a level lower than a portion reaching the break-through point of the boron adsorption resin.
